(19) United States
(12) Patent Application Publication
(10) Pub. No.: US 2024/0083357 A1
(43) Pub. Date: Mar. 14, 2024

(54) Rear View Assembly for a Motor Vehicle

(71) Applicant: Motherson Innovations Company Limited, London (GB)

(72) Inventors: Anthony P. D'Andrea, Attica, MI (US); Gary Sinelli, Birmingham, MI (US); Donald DePalma, Armada, MI (US)

(21) Appl. No.: 18/461,684

(22) Filed: Sep. 6, 2023

Related U.S. Application Data
(60) Provisional application No. 63/404,930, filed on Sep. 8, 2022.

(51) Int. Cl. B60R 1/062

(52) U.S. Cl. CPC B60R 1/062

(57) ABSTRACT

A rear view assembly for a vehicle comprises a rear view device having a viewing element and a housing, wherein the rear view device is attached to the vehicle via a mounting structure. The mounting structure comprises a base frame having an upper plate, a lower plate, a middle portion, a first mounting portion and a second mounting portion; a shaft configured on the base frame, and at least one fold arm configured on the shaft via a powerfold mechanism. The first mounting portion of the base frame is mounted on the vehicle at a first mounting location and the second mounting portion of the base frame is mounted on the vehicle at a second mounting location. The first mounting location is spaced apart from the second mounting location.

### CROSS-REFERENCE TO RELATED APPLICATION

This application claims priority to U.S. Provisional Patent Application No. 63/404,930, titled “Trailer Tow Bridge Base,” filed on Sep. 8, 2022, the entirety of which is incorporated herein by reference.

### FIELD

The present disclosure relates to motor vehicle external rear view assembly.

### BACKGROUND

The statements in this section merely provide background information related to the present disclosure and may not constitute prior art.

Power telescoping mirrors were developed to allow a rear view device to be extended or retracted by a user from inside a vehicle. The extension and retraction of the rear view device can be controlled to accommodate different conditions desired by the user. These conditions include the width and length of the towing vehicle. One problem faced by power telescoping mirrors is supporting the weight of the rear view device and all accessories/features included in the rear view device when fully extended. Another problem faced by these mirrors is the level of vibration due to lack of rigid support. A further problem faced is pivoting the mirror assembly including the telescoping structure needed to support a fully extended rear view device. Another problem is current telescoping mirrors pivot the mirror head or the mirror reflective element which limits the field of vision available. Information relevant to attempts to address these problems can be found in U.S. Pat. App. Pub. No. 2019/0016265, U.S. Pat. Nos. 7,172,298 and 6,726,337. However, each one of these references suffers from the disadvantages of a telescoping design which has a limited range for pivoting adjustment. Each of these references are mounted on the vehicle via only one mounting structure, which may lead to non-rigid structure and may lead to vibration in the mirror.

### SUMMARY

Generally the present disclosure provides a rear view assembly for a vehicle.

In one embodiment, a rear view assembly comprises: a rear view device having a viewing element and a housing, wherein the rear view device is attached to the vehicle via a mounting structure; the mounting structure comprising: a base frame having an upper plate, a lower plate, a middle portion, a first mounting portion and a second mounting portion, a shaft configured on the base frame, and at least one fold arm configured on the shaft via a powerfold mechanism, the fold arm having a first end and a second end, wherein the first end of the fold arm is coupled to the shaft and the second end is coupled to the rear view device; a base cover surrounding the base frame; and an arm cover configured between the base cover and the rear view device, wherein the first mounting portion of the base frame is mounted on the vehicle at a first mounting location and the second mounting portion of the base frame is mounted on the vehicle at a second mounting location, wherein the first mounting location is spaced apart from the second mounting location.

In another embodiment, a rear view assembly comprises: a rear view device having a viewing element and a housing, wherein the rear view device is attached to the vehicle via a mounting structure; and the mounting structure comprising: a base frame having an upper plate, a lower plate, a middle portion, a first mounting portion and a second mounting portion, and at least one fold arm configured on a powerfold mechanism, the fold arm having a first end and a second end, wherein the first end of the fold arm is coupled to the base frame and the second end is coupled to the rear view device, wherein the first mounting portion of the base frame is mounted on the vehicle at a first mounting location and the second mounting portion of the base frame is mounted on the vehicle at a second mounting location, and wherein the first mounting location is a sheet metal inner reinforcement of the vehicle, and the second mounting location is a sheet metal patch area of the vehicle.

In another embodiment, a rear view assembly comprises: a rear view device having a viewing element and a housing, wherein the rear view device is attached to the vehicle via a mounting structure; and the mounting structure comprising: a base frame having an upper plate, a lower plate, a middle portion, a first mounting portion and a second mounting portion, a shaft configured on the base frame, and at least one fold arm configured on the shaft via a powerfold mechanism, the fold arm having a first end and a second end, wherein the first end of the fold arm is coupled to the shaft and the second end is coupled to the rear view device, wherein the first mounting portion of the base frame is mounted on the vehicle at a first mounting location and the second mounting portion of the base frame is mounted on the vehicle at a second mounting location, and wherein a first piece comprises the upper plate; and a second piece comprises the first mounting portion, the middle portion, the second mounting portion and the lower plate.

In another embodiment, a rear view assembly comprises: a rear view device having a viewing element and a housing, wherein the rear view device is attached to the vehicle via a mounting structure; and the mounting structure comprising: a base frame having an upper plate, a lower plate, a middle portion, a first mounting portion and a second mounting portion; a shaft configured on the base frame, at least one fold arm configured on the shaft via a powerfold mechanism, the fold arm having a first end and a second end, wherein the first end of the fold arm is coupled to the shaft and the second end is coupled to the rear view device, wherein the first mounting portion of the base frame is mounted on the vehicle at a first mounting location and the second mounting portion of the base frame is mounted on the vehicle at a second location, and wherein a first piece comprises the upper plate; a second piece comprises the first mounting portion, the middle portion and the second mounting portion; and a third piece comprises the lower plate.

In another embodiment, a rear view assembly comprises: a rear view device having a viewing element and a housing, wherein the rear view device is attached to the vehicle via a mounting structure; and the mounting structure comprising: a base frame having an upper plate, a lower plate, a middle portion, a first mounting portion and a second mounting portion, a shaft configured on the base frame, wherein each of the upper plate and the lower plate has a shaft receiving portion for receiving one end of the shaft, and at least one fold arm configured on the shaft via a powerfold mechanism, the fold arm having a first end and a second end, wherein the first end of the fold arm is coupled to the shaft and the second end is coupled to the rear view device, wherein the first mounting portion of the base frame is mounted on the vehicle at a first mounting location and the second mounting portion of the base frame is mounted on the vehicle at a second mounting location, and wherein a first piece comprises the upper plate and the second mounting portion of the base frame, a second piece comprises the middle portion of the base frame, and a third piece comprises the lower plate and the first mounting portion.

### BRIEF DESCRIPTION OF THE DRAWINGS

In order that the disclosure may be well understood, there will now be described various forms thereof, given by way of example, reference being made to the accompanying drawings, in which:

FIG. 1 is an isometric, assembled view of a rear view assembly, in accordance with an embodiment.

FIG. 2 is an isometric view of the rear view assembly with removed rear view device, in accordance with an embodiment.

FIG. 3 is isometric view of a mounting structure of the rear view assembly, in accordance with an embodiment.

FIG. 4 is an exploded view of a base frame of the rear view device, in accordance with an embodiment.

FIG. 5 is an isometric view of the base frame of FIG. 4 assembled with the vehicle, in accordance with an embodiment.

FIG. 6 is a side view of the base frame of FIGS. 4-5 assembled with the vehicle, in accordance with an embodiment.

FIG. 7 is an isometric view of the base frame of FIGS. 4-6 with removed upper plate, in accordance with an embodiment.

FIG. 8 is an isometric view of a rear view assembly mounted on a vehicle, in accordance with another embodiment.

FIG. 9 is an isometric back view of the rear view assembly of FIG. 8, in accordance with an embodiment.

FIG. 10 is an isometric view of the rear view assembly of FIGS. 8-9 illustrating a base frame and a rear view device, in accordance with an embodiment.

FIG. 11 is an assembled view of a mounting structure, in accordance with an embodiment of FIGS. 8-10.

FIG. 12 is an exploded view of the mounting structure of FIG. 11, in accordance with an embodiment.

FIG. 13 is an assembled view of the base frame of FIGS. 10-12, in accordance with an embodiment.

FIG. 14 is an exploded view of the base frame of FIGS. 10-13, in accordance with an embodiment.

FIG. 15 illustrates the base frame of FIGS. 10-14 with removed upper plate and lower plate, in accordance with an embodiment.

FIG. 16 illustrates the base frame of FIGS. 10-15 mounted on the vehicle with removed upper plate and lower plate, in accordance with an embodiment.

FIG. 17 is an exploded view of a base frame, in accordance with another embodiment.

FIG. 18 is an isometric view of the base frame of FIG. 17, in accordance with an embodiment.

### DETAILED DESCRIPTION

The following description is merely exemplary in nature and is not intended to limit the present disclosure, application, or uses. It should be understood that throughout the drawings, corresponding reference numerals indicate like or corresponding parts and features.

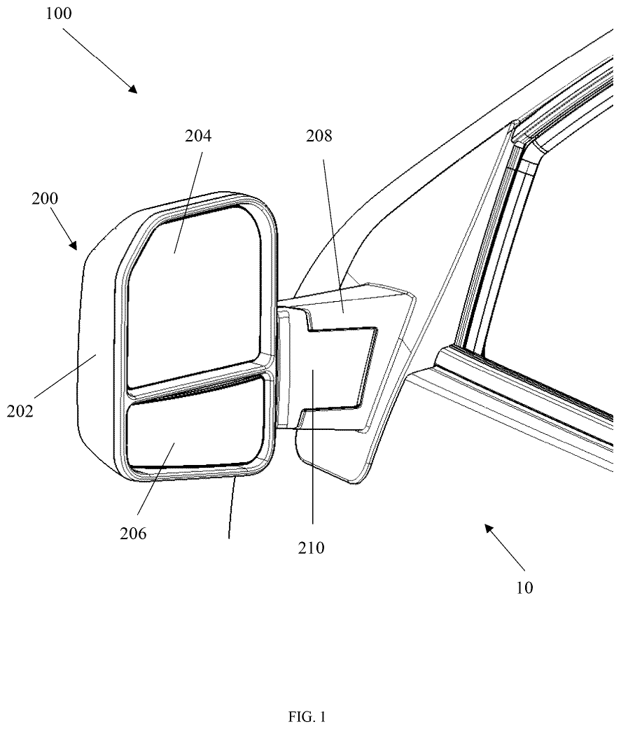

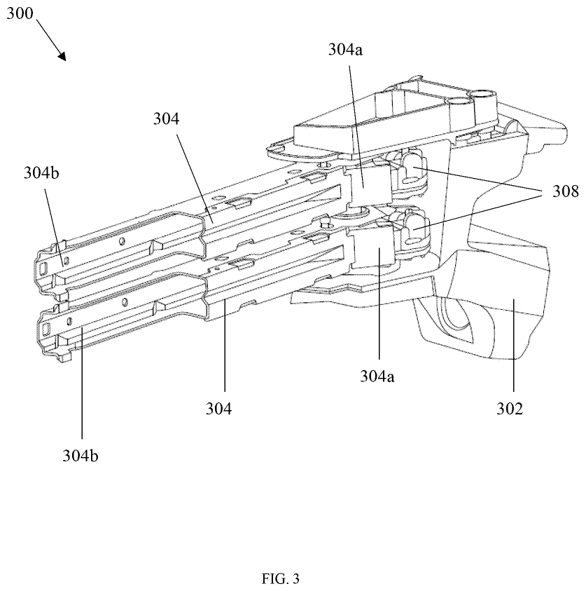

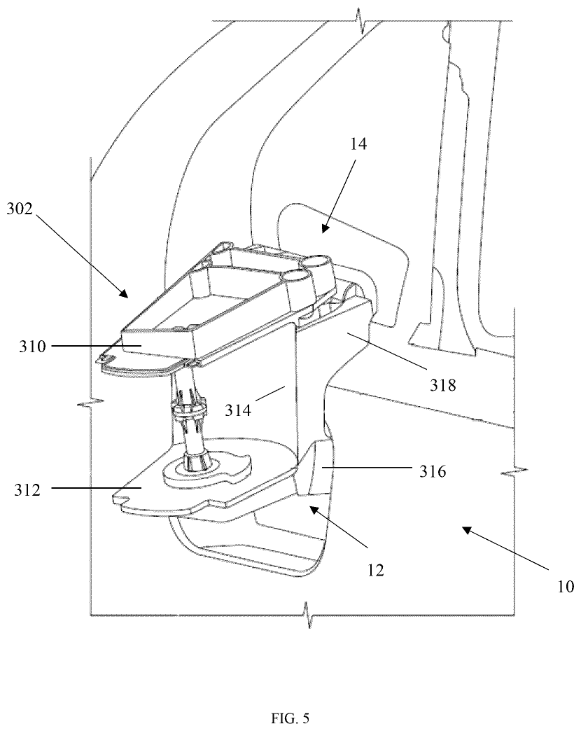

FIG. 1 illustrates a rear view assembly 100 mounted on a vehicle 10. The rear view assembly 100 comprises a rear view device 200. The rear view device 200 may comprise a telescopic rear view device having a housing 202 and at least one rear view element 204, 206. In the illustrated embodiment, the rear view element comprises a first mirror 204 and a second mirror 206 for obtaining various fields of view surrounding the vehicle 10. In another embodiment (not shown) combination of different rear view elements may be possible. That is to say, the rear view element may comprise a combination of a mirror and a camera for obtaining various fields of view of the vehicle 10. As shown in FIG. 1, the rear view assembly 100 further comprises a base cover 208 and an arm cover 210. The arm cover 210 may be slidably attached to the base cover 208 and attached to the rear view device 200. The base cover 208 covers a base frame 302 (shown in FIG. 3) of the rear view assembly 100 and a vehicle mounting area (shown in FIGS. 5-7). The arm cover 210 may cover at least one fold arm 304 (shown in FIG. 3) and may extend and retract with the rear view device 200.

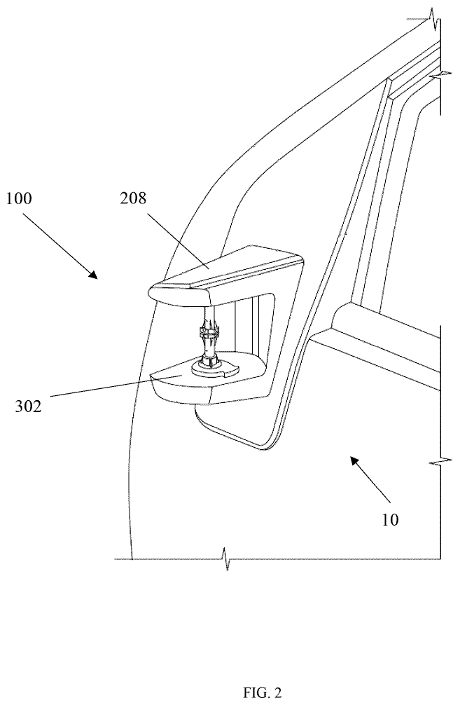

FIG. 2 illustrates the rear view assembly 100 with removed rear view device 200 and the arm cover. As shown in the figure, the base cover 208 covers the base frame 302.

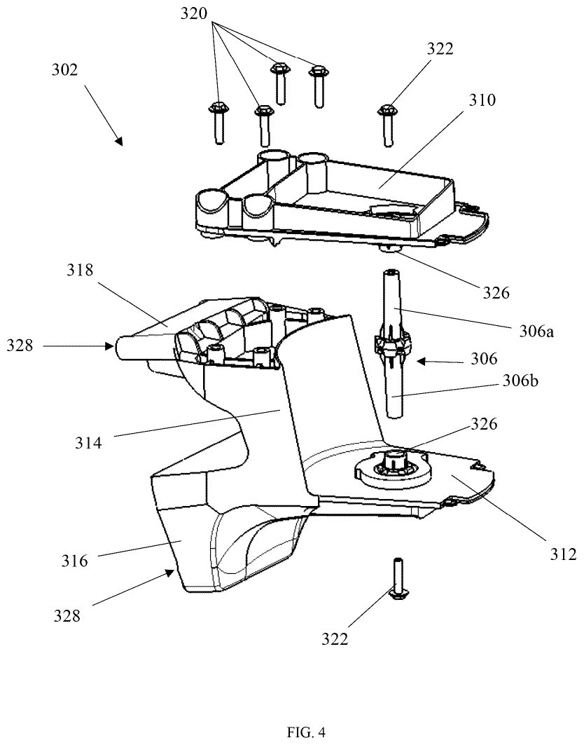

FIG. 3 illustrates an isometric view of the mounting structure 300. The rear view device 200 is attached to the vehicle 10 via the mounting structure 300. The mounting structure 300 comprises the base frame 302, a shaft 306 (shown in FIG. 4) configured on the base frame 302. The at least one fold arm 304 is configured on the shaft 306 via a powerfold mechanism 308. The at least one fold arm 304 may comprise one or more fold arms. In the illustrated embodiment, the at least one fold arm 304 comprises two fold arms 304. The fold arms 304 has a first end 304a and a second end 304b. The first end 304a of the fold arms 304 is coupled to the powerfold mechanism 308 which is rotatably coupled to the shaft 306. The second end 304b of the fold arms 304 is attached to the rear view device 200. When the powerfold mechanism 308 is actuated the fold arms coupled to with the powerfold mechanism 308 rotate with the powerfold mechanism 308 in order to obtain folded and unfolded positions of the rear view device 200. In another embodiment, the folding and unfolding of the rear view device 200 may be done manually. In another embodiment, the at least one fold arm 304 may comprise three or more fold arms. The fold arm 304 is configured to extend and retract to in order to enhance the field of view of the rear view device. The extension and retraction of fold arm 304 is possible by adjusting the length of the fold arm 304. That is to say, the fold arm 304 may comprise a sliding mechanism (not shown) for adjusting the length of the fold arm 304. The length of the fold arm 304 may be adjusted manually or via an actuating mechanism. In another embodiment, the fold arm may be non-extendable, i.e., the length of the fold arm 304 may be fixed.

FIG. 4 illustrates a base frame 302 according to a first embodiment. As shown in the figure, the base frame 302 comprises an upper plate 310, a lower plate 312, a middle portion 314, a first mounting portion 316, a second mounting portion 318 and the shaft 306. The base frame 302 comprises a first piece and a second piece. The first piece comprises the upper plate 310. The second piece comprises the lower plate 312, the middle portion 314, the first mounting portion 316, and the second mounting portion 318. The first piece is attached to the second piece via at least one fastener 320. The upper plate 310 and the lower plate 312 has a shaft receiving portion 326. The shaft receiving portion 326 is shaped in such a way that the ends of the shaft 306 is rigidly fixed between the upper plate 310 and the lower plate 312. The shaft 306 is also tightened on the upper plate and the lower plate by a fastener 322. The shaft 306 is spaced apart from the middle portion 314 of the base frame 302 for allowing a space for the powerfold mechanism 308. The shaft 306 may comprise an upper portion 306a and a lower portion 306b joined together axially. The upper portion 306a is inserted into the shaft receiving portion 326 of the upper plate 310. The lower portion 306b is inserted into the shaft receiving portion 326 of the lower plate 312. Each of the upper portion 306a and the lower portion 306b of the shaft 306 is coupled with one powerfold mechanism 308 and one fold arm 304.

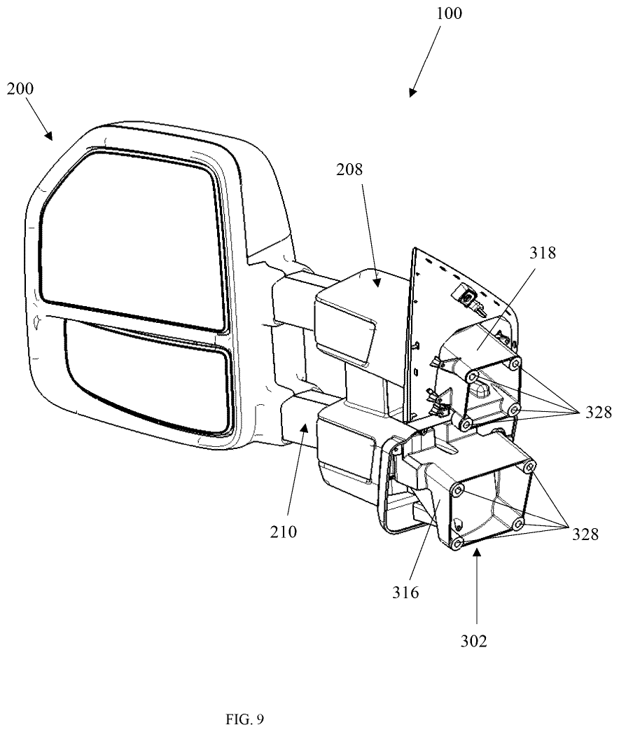

The first mounting portion 316 and the second mounting portion 318 have a plurality of holes 328 (not visible in this embodiment, shown in FIG. 9) for mounting the base frame 302 to the vehicle 10 via a plurality of mounting devices. The mounting devices may comprise a plurality of screws, studs, bolts or combination thereof. The first mounting portion 316 is spaced apart from the second mounting portion 318 and each connected to the middle portion 314 to form a bridge shaped structure of the base frame 302. The bridge shaped structure allows the base frame 302 to be mounted on the vehicle 10 at two different locations which provides rigidity to the mounting structure 300 and supports the weight of the rear view device 200 even when the rear view device 200 is extended.

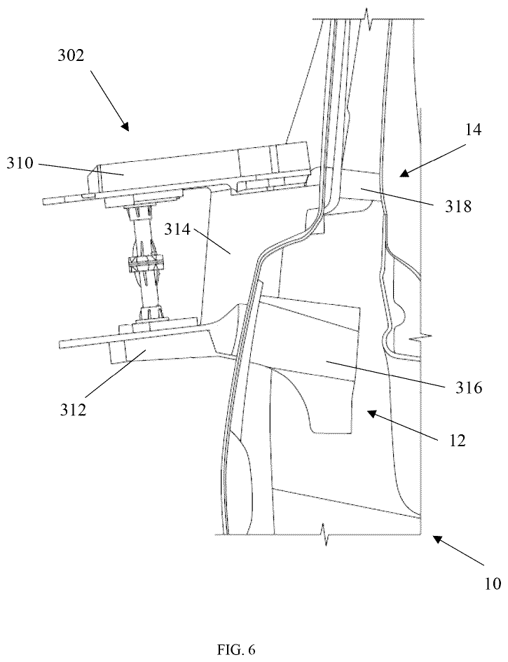

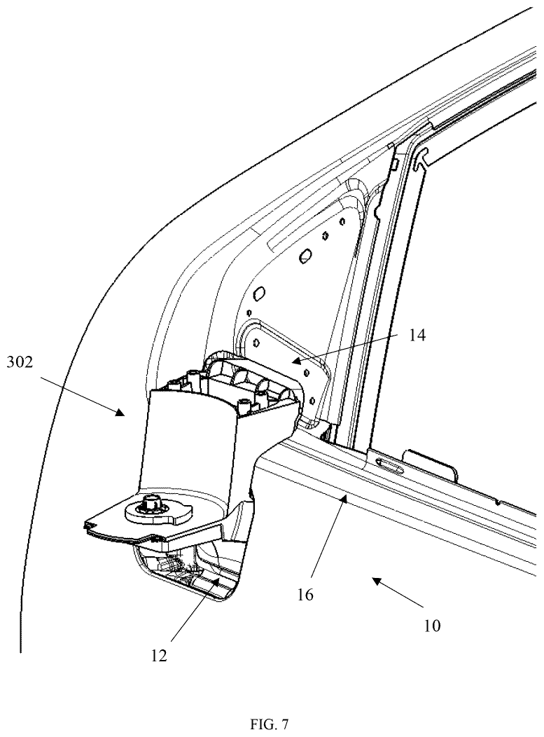

Referring to FIG. 5, FIG. 6 and FIG. 7, which illustrate the assembly of the base frame 302 with the vehicle 10. The base frame 302 is mounted on the vehicle 10 at two mounting locations. The first mounting portion 316 of the base frame 302 is mounted on a first mounting location 12, and the second mounting portion 318 of the base frame 302 is mounted on a second mounting location 14. The first mounting location 12 is spaced apart from the second mounting location 14. The first mounting location 12 is a sheet metal inner reinforcement of the vehicle door, and the second mounting location 14 is a sheet metal patch area of the vehicle door. The first mounting location 12 is separated from the second mounting location 14 by window line 16 of the door (shown in FIG. 7). The advantage of mounting the base frame 302 on such mounting locations on the vehicle door is that the base frame 302 is supported on the vehicle door at two different locations which provides rigid support to the rear view assembly 100. This also prevents vibration in the rear view assembly 100. Another advantage of having such mounting locations is that the rear view assembly 100 provides a better field of view as compared to conventional rear view assemblies that are usually mounted either on the patch area of the vehicle door or on the inner reinforcement of the vehicle door.

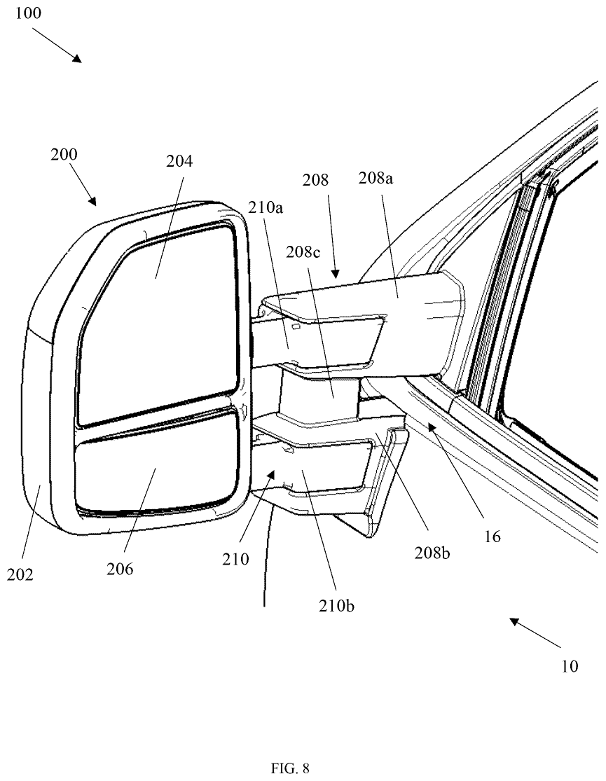

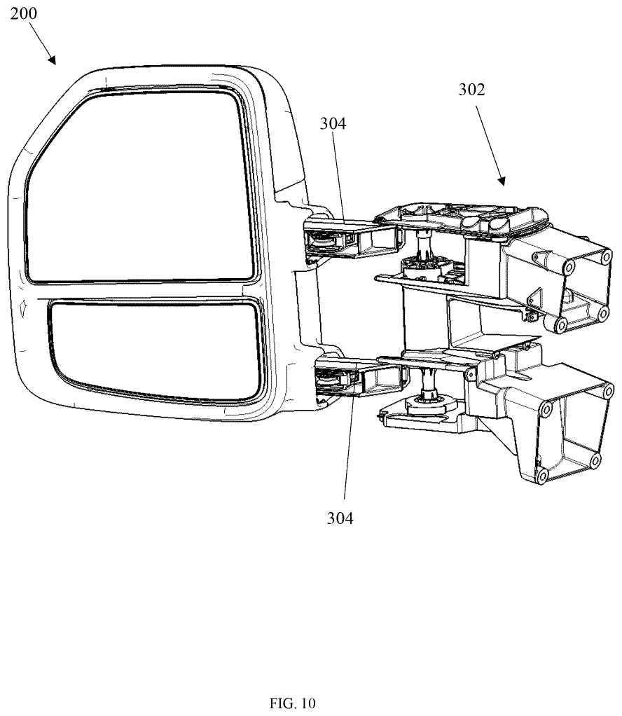

FIG. 8 illustrates another embodiment of the rear view assembly 100. The rear view device 200 remains the same as described in the previous embodiment and is therefore not further described here. The base cover 208 and the arm cover 210 in this embodiment have different shapes as compared to the previous embodiment. As shown in FIG. 8, the base cover 208 covers the base frame 302, shown in FIG. 9. The base cover 208 has an upper part 208a, and a lower part 208b connected to the upper part 208a via a middle part 208c. At the mounting locations, the upper part 208a of the base cover 208 is separated from the lower part 208b of the base cover 208 by the window line 16 of the door of the vehicle 10. The arm cover 210 also comprises two separate arm covers for each fold arm 304 (shown in FIG. 10). The arm cover 210a is attached to the upper part 208a of the base cover 208, and the arm cover 210b is attached to the lower part 208b of the base cover 208.

FIG. 9 is a back view of the rear view assembly 100 of FIG. 8 when removed from the vehicle 10 to illustrate the first mounting portion 316 and the second mounting portion 318 of the base frame 302. As shown in the figure, the first mounting portion 316 and the second mounting portion 318 have a plurality of holes 328 for mounting the base frame 302 to the vehicle 10 via a plurality of mounting devices. The mounting devices may include screws, studs, bolts or combination thereof.

FIG. 10 is a back view of the rear view assembly 100 of FIG. 9 with the base cover 208 and arm cover 210 removed. As shown in the figure the base frame 302 has a different structure as compared to the previous embodiment which is described below. The fold arm 304 of this embodiment remains the same as compared to the previous embodiment except that the gap between the two fold arms are slightly more in this embodiment.

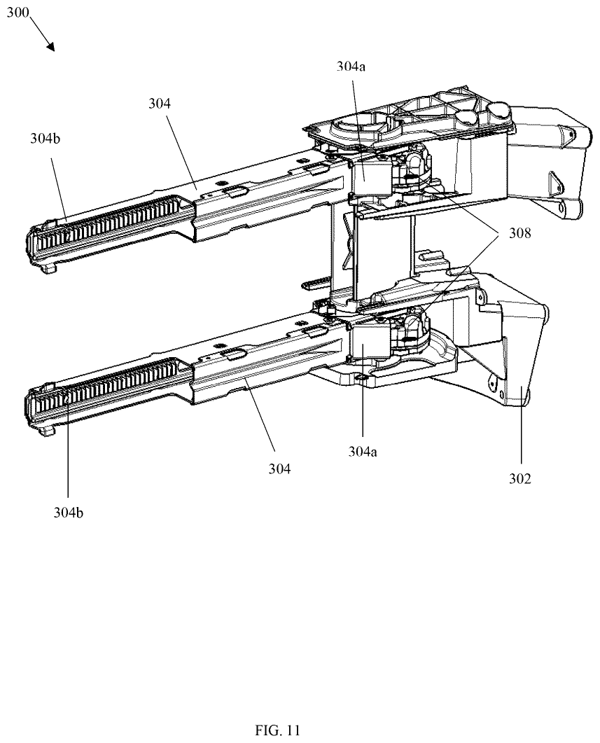

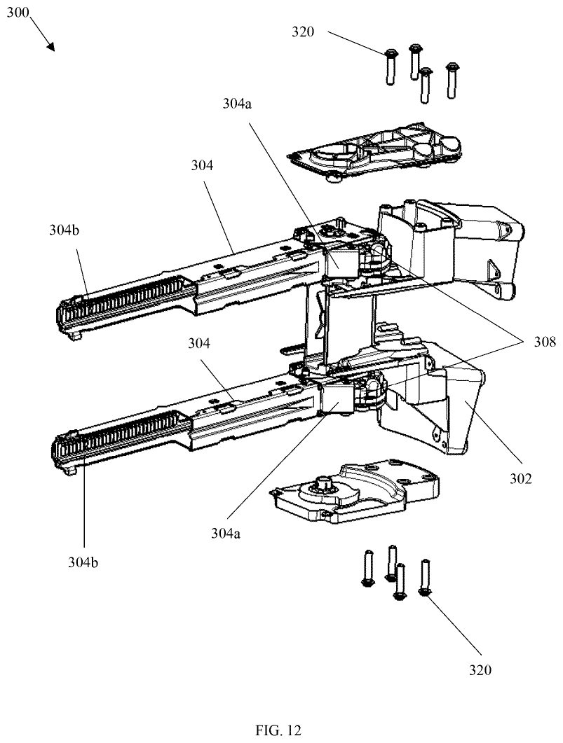

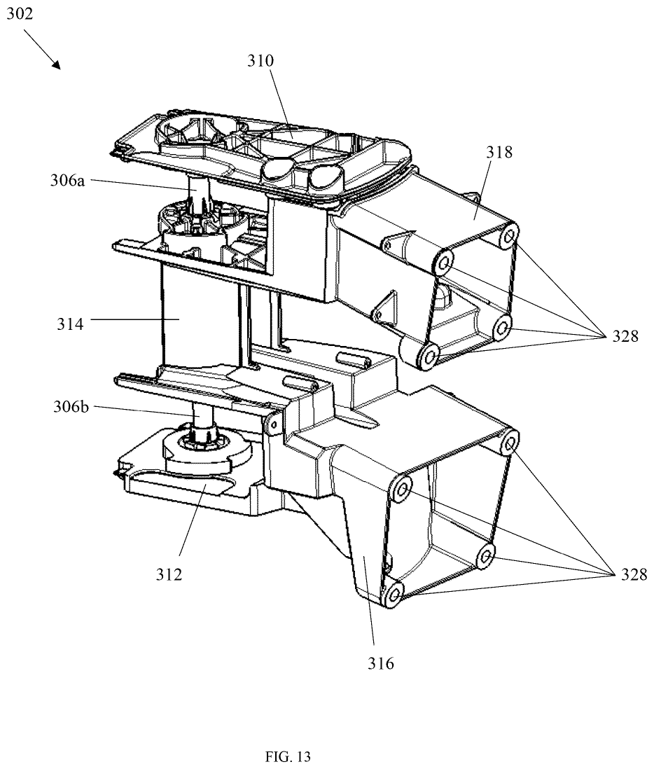

FIG. 11 is an assembled view of the mounting structure 300, and FIG. 12 is an exploded view of the mounting structure 300. The mounting structure 300 includes the base frame 302, at least one fold arm 304, and the powerfold mechanism 308. The arrangement of the fold arm 304 and the powerfold mechanism remains the same, and is therefore not further described. The base frame 302 of this embodiment is different from the base frame 302 of the previous embodiment and is described below with reference to FIGS. 13-16.

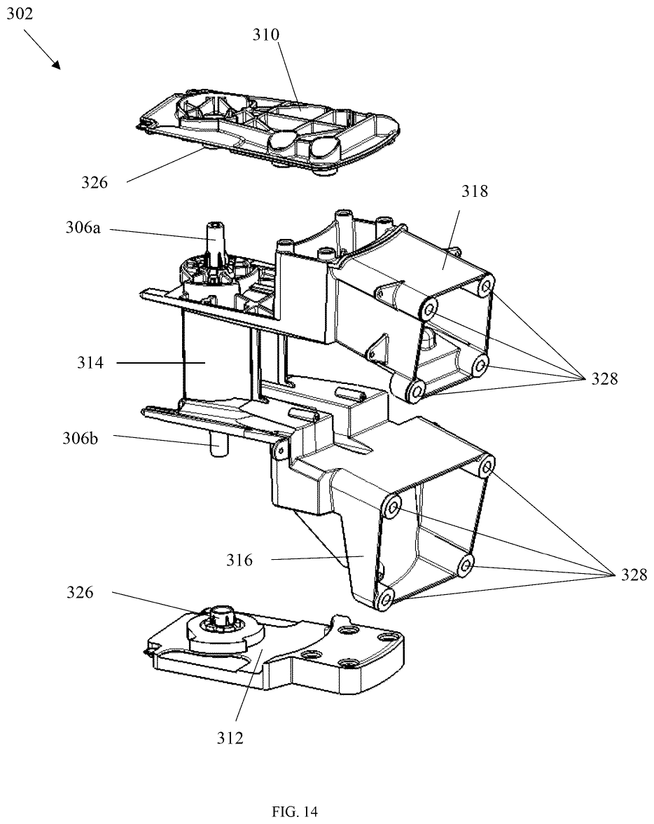

Referring to FIG. 13 and FIG. 14, the base frame 302 comprises the upper plate 310, the lower plate 312, the middle portion 314, the first mounting portion 316, the second mounting portion 318 and the shaft 306a, 306b. The base frame 302 comprises a first piece, a second piece and a third piece. The first piece comprises the upper plate 310. The second piece comprises the middle portion 314, the first mounting portion 316, and the second mounting portion 318. The third piece comprises the lower plate 312. The first piece and the third piece are attached to the second piece via at least one fastener 320 (shown in FIG. 12). The shaft comprises the upper shaft portion 306a and the lower shaft portion 306b configured separately on the middle portion 314 of the base frame 302. The upper shaft portion 306a and the lower shaft portion 306b are spaced apart by the middle portion 314 of the base frame 302. The upper plate 310 receives one end of the upper shaft portion 306a in the shaft receiving portion 326. The lower plate 312 receives one end of the lower shaft portion 306b in the shaft receiving portion 326. The first mounting portion 31, the middle portion 314 and the second mounting portion 318 form a bridge shaped or a U-shaped structure.

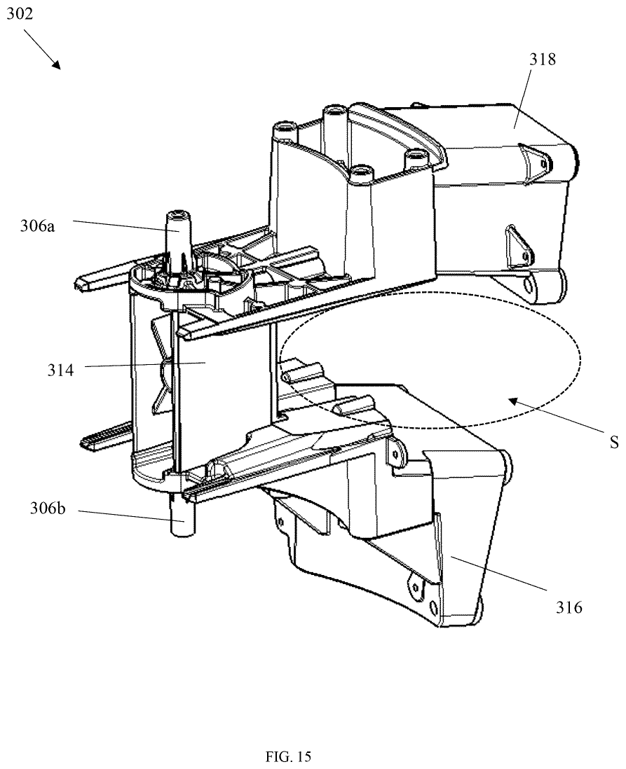

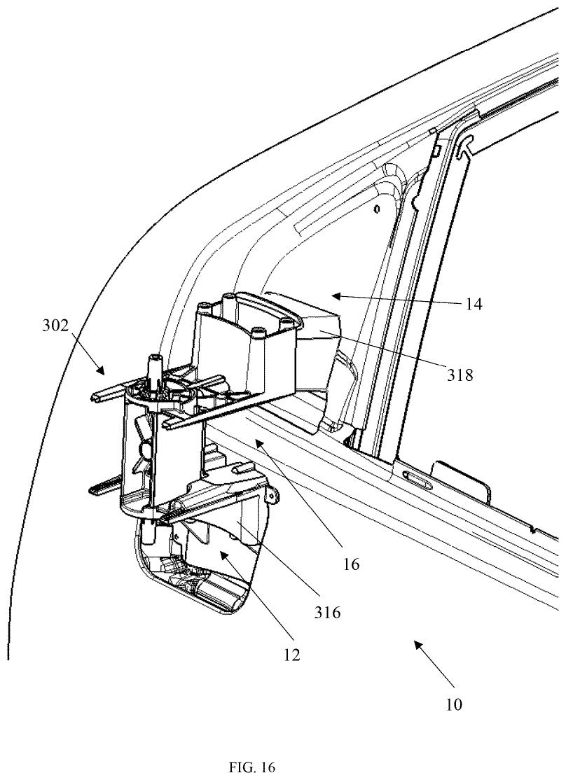

FIG. 15 illustrates the second piece of the base frame 302 with the removed upper plate 310 and the lower plate 312. As shown in the figure, the middle portion 314 is slightly narrower than the middle portion 314 of the previous embodiment. This allows more usable space (S) between the first mounting portion 316, the second mounting portion 318 and the middle portion 314. An advantage of having more usable space is described with reference to FIG. 16.

FIG. 16 illustrates the base frame 302 of FIG. 15 mounted on the vehicle 10. As shown in the figure, the base frame 302 is mounted on the vehicle 10 at two mounting locations. The first mounting location 12 is the sheet metal inner reinforcement of the vehicle door, and the second mounting location 14 is the sheet metal patch area of the vehicle door. The window line 16 separates the two mounting locations 12, 14. As seen in FIG. 15, there is more usable space (S) between the first mounting portion 316, the second mounting portion 318 and the middle portion 314. This space (S) is accommodated by the window line 16, and the portion of the window line 16 which is accommodated between the first mounting portion 316 and the second mounting portion 318 of the base frame 302 is not required to be adjusted or removed. The other advantages of the previous embodiment may also be applicable to this embodiment.

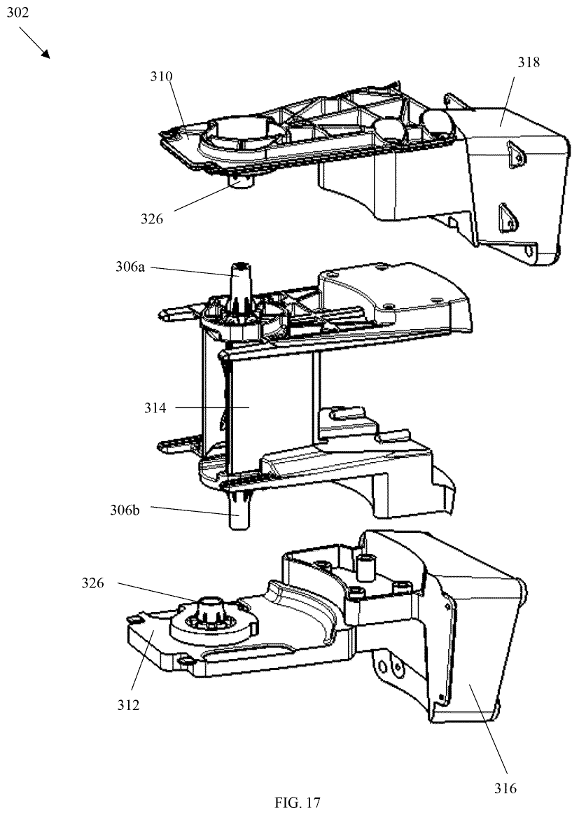

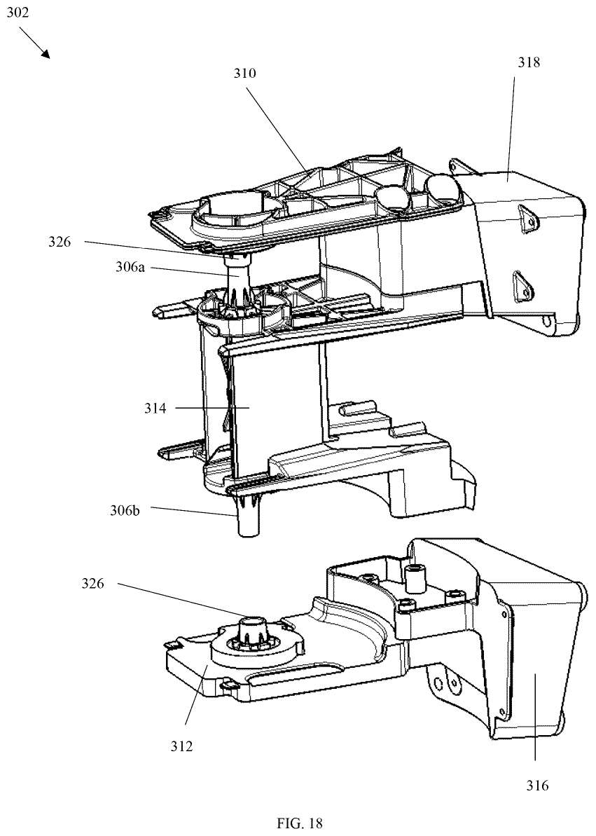

FIG. 17 and FIG. 18 illustrate another embodiment of the base frame 302. The base frame 302 of this embodiment is similar to the base frame 302 of the embodiment of FIGS. 8-16. The difference between the embodiments is described below. The base frame 302 comprises a first piece, a second piece and a third piece. The first piece comprises the upper plate 310 and the second mounting portion 318. The second piece comprises the middle portion 314. The third piece comprises the lower plate 312 and the first mounting portion 316. The first piece and the third piece are attached to the second piece via at least one fastener 320. The advantages of this embodiment may be similar to the advantages of the previous embodiment.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

Furthermore, the features of the disclosure disclosed in this specification, the claims and the drawings may be employed both individually and in any possible combination for 5 practicing the disclosure in its various exemplary embodiments. In particular, all claim feature combinations, irrespective of the claim dependencies, are covered with this application.

### REFERENCE LIST

10—Vehicle
12—First Mounting Location
14—Second Mounting Location
16—Window Line of Vehicle
100—Rear View Assembly
200—Rear View Assembly
202—Housing
204—Rear View Element/First Mirror
206—Rear View Element/Second Mirror
208—Base Cover
208a—Upper Part of Base Cover
208b—Lower Part of Base Cover
208c—Middle Part of Base Cover
210—Arm Cover
210a—Arm Cover
210b—Arm Cover
300—Mounting Structure
302—Base Frame
304—Fold Arm
304a—First End of Fold Arm
304b—Second End of Fold Arm
306—Shaft
306a—Upper portion of Shaft
306b—Lower Portion of Shaft
308—Powerfold Mechanism
310—Upper Plate
312—Lower Plate
314—Middle Portion
316—First Mounting Portion
318—Second Mounting Portion
320—Fastener
322—Fastener
326—Shaft Receiving Portion
328—Plurality of Holes
S—Space

What is claimed is:

1. A rear view assembly for a vehicle, the rear view assembly comprising:
a rear view device having a viewing element and a housing, wherein the rear view device is attached to the vehicle via a mounting structure, the mounting structure comprising:
a base frame including an upper plate, a lower plate, a middle portion, a first mounting portion and a second mounting portion;
a shaft configured on the base frame;
at least one fold arm configured on the shaft via a powerfold mechanism, the fold arm having a first end and a second end, wherein the first end of the fold arm is coupled to the shaft and the second end is coupled to the rear view device;
a base cover configured on the base frame; and
an arm cover configured between the base cover and the rear view device,
wherein the first mounting portion of the base frame is mounted on the vehicle at a first mounting location and the second mounting portion of the base frame is mounted on the vehicle at a second mounting location, wherein the first mounting location is spaced apart from the second mounting location.

2. The rear view assembly as claimed in claim 1, wherein the first mounting portion is spaced apart from the second mounting portion, and the first mounting portion and the second mounting portion are connected to the middle portion of the base frame to form a bridge shaped structure.

3. The rear view assembly as claimed in claim 1, wherein the first mounting location is sheet metal inner reinforcement of the vehicle and the second mounting location is sheet metal patch area of the vehicle.

4. The rear view assembly as claimed in claim 1, wherein each of the upper plate and the lower plate has a shaft receiving portion.

5. The rear view assembly as claimed in claim 1, wherein each of the first mounting portion and the second mounting portion of the base frame has a plurality of holes for mounting the base frame to the vehicle.

6. The rear view assembly as claimed in claim 1, wherein each of the first mounting portion and the second mounting portion of the base frame is mounted on the vehicle via a plurality of mounting devices.

7. The rear view assembly as claimed in claim 6, wherein the plurality of mounting devices comprises screws, studs, bolts, nuts and/or combinations thereof.

8. The rear view assembly as claimed in claim 1, wherein the powerfold mechanism is configured to rotate the fold arm about the shaft for folding and unfolding the rear view device.

9. The rear view assembly as claimed in claim 1, wherein the rear view device is configured to be folded and unfolded manually.

10. The rear view assembly as claimed in claim 1, wherein the base frame comprises multiple pieces.

11. The rear view assembly as claimed in claim 10, wherein
a first piece comprises the upper plate; and
a second piece comprises the first mounting portion, the middle portion, the second mounting portion and the lower plate.

12. The rear view assembly as claimed in claim 11, wherein the first piece is attached to the second piece via at least one fastener.

13. The rear view assembly as claimed in claim 10, wherein
a first piece comprises the upper plate;
a second piece comprises the first mounting portion, the middle portion and the second mounting portion; and
a third piece comprises the lower plate.

14. The rear view assembly as claimed in claim 13, wherein the first piece is attached to the second piece via at least one fastener and the third piece is attached to the second piece via at least one fastener.

15. The rear view assembly as claimed in claim 10, wherein
a first piece comprises the upper plate and the first mounting portion of the base frame;
a second piece comprises the middle portion of the base frame; and
a third piece comprises the lower plate and the second mounting portion.

16. The rear view assembly as claimed in claim 15, wherein the first piece is attached to the second piece via at least one fastener and the third piece is attached to the second piece via at least one fastener.

17. The rear view assembly as claimed in claim 1, wherein the viewing element comprises at least one mirror, at least one camera and/or combinations thereof.

18. The rear view assembly as claimed in claim 1, wherein length of the fold arm is fixed.

19. The rear view assembly as claimed in claim 1, wherein the fold arm is configured to extend and retract.

20. The rear view assembly as claimed in claim 19, wherein the fold arm comprise a sliding mechanism for adjusting length of the fold arm.

21. The rear view assembly as claimed in claim 19, wherein length of the fold arm is adjusted manually.

22. The rear view assembly as claimed in claim 19, wherein length of the fold arm is configured to be adjusted by an actuating mechanism.

23. A rear view assembly for a vehicle, the rear view assembly comprising:
a rear view device having a viewing element and a housing, wherein the rear view device is attached to the vehicle via a mounting structure, the mounting structure comprising:
a base frame having an upper plate, a lower plate, a middle portion, a first mounting portion and a second mounting portion; and
at least one fold arm configured on a powerfold mechanism, the fold arm having a first end and a second end, wherein the first end of the fold arm is coupled to the base frame and the second end is coupled to the rear view device;
wherein the first mounting portion of the base frame is mounted on the vehicle at a first mounting location and the second mounting portion of the base frame is mounted on the vehicle at a second mounting location, and wherein the first mounting location is sheet metal inner reinforcement of the vehicle, and the second mounting location is sheet metal patch area of the vehicle.

24. The rear view assembly as claimed in claim 23, wherein the fold arm is configured on the base frame via a shaft, wherein the fold arm is configured to rotate about an axis of the shaft.

25. A rear view assembly for a vehicle, the rear view assembly comprising:
a rear view device having a viewing element and a housing, wherein the rear view device is attached to the vehicle via a mounting structure, the mounting structure comprising:
a base frame having an upper plate, a lower plate, a middle portion, a first mounting portion and a second mounting portion;
a shaft configured on the base frame; and
at least one fold arm configured on the shaft via a powerfold mechanism, the fold arm having a first end and a second end, wherein the first end of the fold arm is coupled to the shaft and the second end is coupled to the rear view device,
wherein the first mounting portion of the base frame is mounted on the vehicle at a first mounting location and the second mounting portion of the base frame is mounted on the vehicle at a second mounting location, and wherein a first piece comprises the upper plate; and a second piece comprises the first mounting portion, the middle portion, the second mounting portion and the lower plate.

26. The rear view assembly as claimed in claim 25, wherein the first piece is attached to the second piece via at least one fastener.

27. A rear view assembly for a vehicle, the rear view assembly comprising:
a rear view device having a viewing element and a housing, wherein the rear view device is attached to the vehicle via a mounting structure, and the mounting structure comprising:
a base frame having an upper plate, a lower plate, a middle portion, a first mounting portion and a second mounting portion;
a shaft configured on the base frame; and
at least one fold arm configured on the shaft via a powerfold mechanism, the fold arm having a first end and a second end, wherein the first end of the fold arm is coupled to the shaft and the second end is coupled to the rear view device,
wherein the first mounting portion of the base frame is mounted on the vehicle at a first mounting location and the second mounting portion of the base frame is mounted on the vehicle at a second location, and wherein a first piece comprises the upper plate; a second piece comprises the first mounting portion, the middle portion and the second mounting portion; and a third piece comprises the lower plate.

28. The rear view assembly as claimed in claim 27, wherein the first piece is attached to the second piece via at least one fastener and the third piece is attached to the second piece via at least one fastener.

29. A rear view assembly for a vehicle, the rear view assembly comprising:
a rear view device having a viewing element and a housing, wherein the rear view device is attached to the vehicle via a mounting structure, the mounting structure comprising:
a base frame having an upper plate, a lower plate, a middle portion, a first mounting portion and a second mounting portion;
a shaft configured on the base frame, wherein each of the upper plate and the lower plate has a shaft receiving portion for receiving one end of the shaft; and
at least one fold arm configured on the shaft via a powerfold mechanism, the fold arm having a first end and a second end, wherein the first end of the fold arm is coupled to the shaft and the second end is coupled to the rear view device;
wherein the first mounting portion of the base frame is mounted on the vehicle at a first mounting location and the second mounting portion of the base frame is mounted on the vehicle at a second mounting location, and wherein a first piece comprises the upper plate and the second mounting portion of the base frame; and second piece comprises the middle portion of the base frame; and a third piece comprises the lower plate and the first mounting portion.

30. The rear view assembly as claimed in claim 29, wherein the first piece is attached to the second piece via at least one fastener and the third piece is attached to the second piece via at least one fastener.
